(19) United States
(12) Patent Application Publication
(10) Pub. No.: US 2007/0065010 A1
(43) Pub. Date: Mar. 22, 2007

(54) Method for segmenting an image

(75) Inventors: Shen-Yuan Shie, Taipei City (TW); Jin-Wen Liao, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/345,304

(22) Filed: Feb. 2, 2006

(30) Foreign Application Priority Data
Sep. 16, 2005 (TW) 094132018

(51) Int. Cl. G06K 9/34; G09G 5/00

(52) U.S. Cl. 382/173; 345/1.3

(57) ABSTRACT

A method for segmenting an image, which divides an image into several sub-images and outputs the same onto an N×N display respectively. (A) identifying coordinates of each of the four corners of the input image and calculating the resolution of the input image; (B) calculating respective sampled positions and resolutions of N×N output sub-images subject to a scale factor of N, wherein N refers to N times the scaling in both vertical and horizontal directions, and the resolution of N×N output sub-images equals to 1/N to the input image; (C) calculating respective sampled images center positions of N×N output sub-images; (D) setting up a register's values of a scaler in a display, including the coordinates and resolutions of the input image, and setting up the values and resolutions of the display; (E) arranging the N×N displays in matrix using OSD, and displaying the N×N output sub-images onto the N×N displays.

### BACKGROUND OF THE INVENTION

1. Field of the Invention

The present invention relates to a method for segmenting an image and, more particularly, for segmenting a single image into multiple image blocks and displaying them on a tiled image display.

2. Description of Related Art

Generally, common tiled image displays observed on the market consist of a plurality of displays arranged in matrix for composing an enlarged image display; for example, a tiled image display consists of four or nine displays that are interconnected and arranged in matrix. A digital signal processor is installed at the rear of the tiled image display. While displaying an image, an input video signal is first segmented within the digital signal processor and then outputted onto the tiled image display. The digital signal processor provides a plurality of output terminals, allowing segmented images to be outputted individually to each tile.

Though the above method for segmenting an image by utilizing the circuit routing can achieve image magnification, arranging the circuit routing can rather be troublesome in practice. While employing the digital signal processor to connect with the displays, each display, representing a single tile, has to be connected to a fixed terminal and cannot be re-adjusted afterward, which in turn complicates the circuit routing and increases the possibility of incorrect wiring. Also, due to the digital signal processor's limitations in terms of its hardware layout, the arrangement of the tiled image display cannot be expanded at the user's request accordingly, causing the dimension of the tiled image display to be restrained from further expansion. Also with the high cost on a digital signal processor, it is therefore desirable to provide an improved yet cost-effective method to replace the method using circuit routings for image distribution and mitigate the abovementioned inadequacies recognized in the prior art.

### SUMMARY OF THE INVENTION

The object of the present invention is to provide a method for segmenting an image by utilizing software to divide a single image into N×N sub-images and output same N×N sub-images onto a tiled image display comprised of N×N displays respectively.

To achieve the above object, the method of the present invention for segmenting an image, particularly to divide an input image into several sub-images and output the same onto a plurality of displays respectively, includes the following steps: (A) identifying coordinates of each of the four corners of the input image and calculating the resolution of the input image; (B) calculating respective sampled positions and resolutions of N×N output sub-images subject to a scale factor of N, wherein N refers to N times the scaling in both vertical and horizontal directions, and the resolution of N×N output sub-images equals to 1/N to the said input image; (C) calculating respective sampled images' center positions of N×N output sub-images; (D) setting up a register's values of a scaler in a display, including the coordinates and resolutions of the input image, and setting up the values and resolutions of the display; and (E) arranging said N×N displays in matrix using on-screen displays (OSD), and displaying the N×N output sub-images onto the N×N displays respectively.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of the preferred embodiment illustrating an image (input) divided into nine sub-images (output) according to the present invention;

FIG. 2 is a flow chart of the method of the preferred embodiment for segmenting an image;

FIG. 3 is the structural diagram of the method of the present invention for segmenting an image.

### DETAILED DESCRIPTION OF THE PREFERRED EMBODIMENT

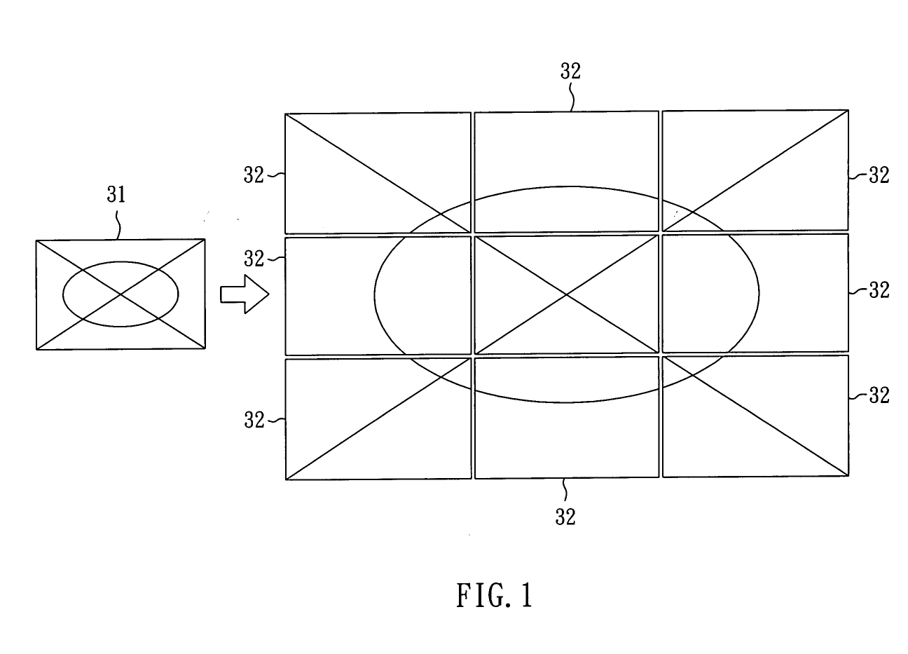

The method of the present invention is for segmenting an image with software by using the scaler inside a display to divide one single image into several sub-images and then display each sub-image onto a tiled image display. With reference to FIG. 1, the schematic diagram of the present invention illustrates an image (input) divided into nine sub-images (output)and explains the method of the present invention for image division, by which after an image is zoomed in threefold both vertically and horizontally, the source image is then divided into nine sub-images, where after the nine sub-images are respectively displayed on nine displays, forming a tiled image display with each output sub-image being zoomed in 9 times larger.

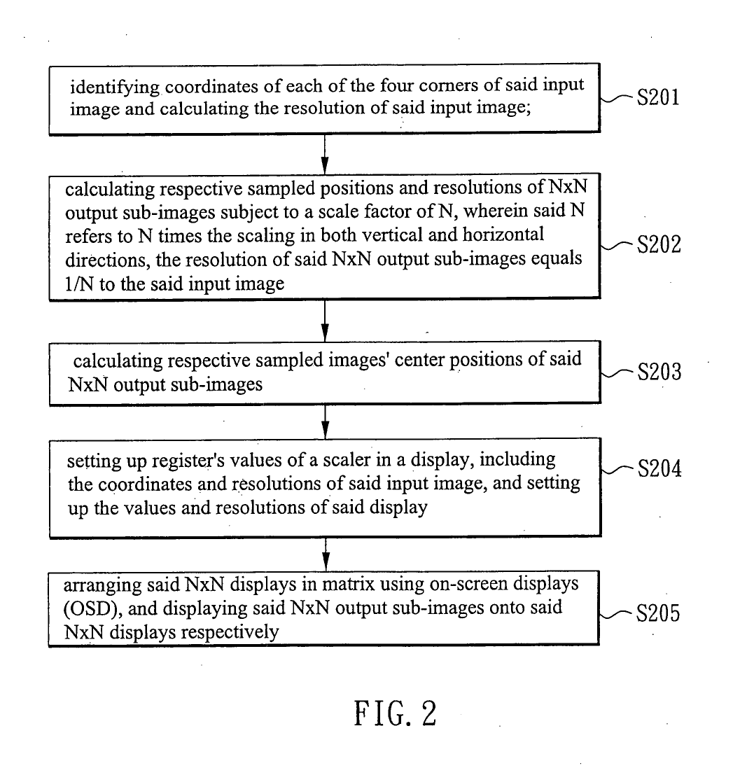

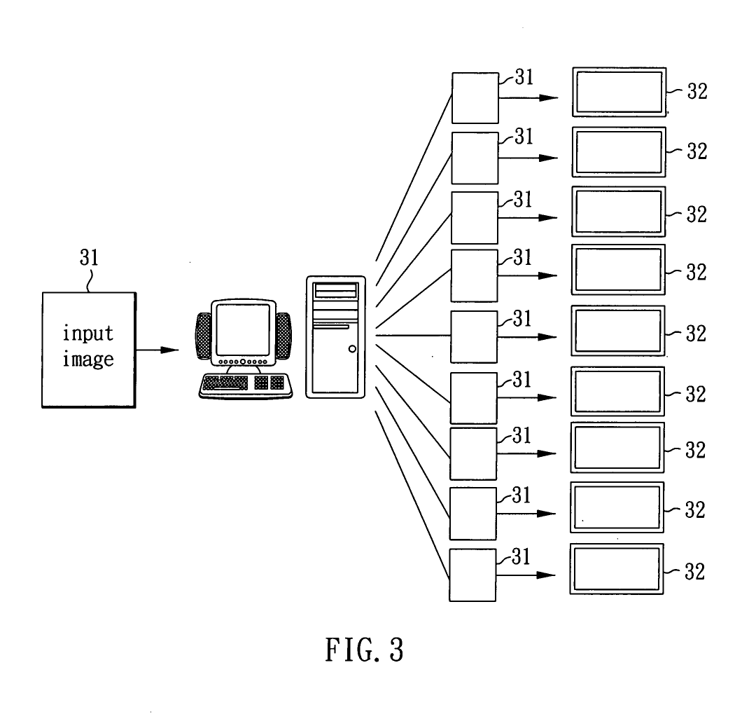

FIG. 2 and FIG. 3 are the flow chart and the system structural map of the method of the present invention for segmenting an image respectively. A set of input images 31 achieved via a signal distributor, are outputted onto displays 32 respectively, and the signals are later sampled, scaled and displayed by the scaler inside each display; the method comprises the following steps of:

First is to identify the coordinates of the input image, including coordinates at each of the four corners, and to calculate the resolution of the input image S201. The input image 31 is a rectangular image comprising four coordinates and a resolution value, for example, the resolution of the input image 31 is 662×442, and four coordinates (0, 0, 662, 442) represent both the relative width and length positions (left, top, right, bottom) of the input image respectively.

Following the above identifications, the resolution of the input image 31 shall be reduced accordingly in order to enlarge the whole image, for which as the fonts shown in the image shrink, the resolution increases; whereas the resolution decreases as the fonts shown in the image become larger. Thus in order to have the input image 31 zoomed in at N times (in both vertical and horizontal directions), each individual sampled position and the resolution of the input image 31 must be adjusted correspondingly down to 1/N times of the source image.

Therefore, each sampled position and resolution of N×N output sub-images are calculated subject to a scale factor of N, where N refers to the scaling factor in both vertical and horizontal directions. The resolution of N×N output sub-images will be 1/N times of the source image (step S202), wherein the size and the resolution of each sub-image are identical except for their sampled positions; for example, having the input image zoomed in 3 times (vertically/horizontally), the resolution of the input image 31 will become one third (⅓) of the source image. Given the resolution of the original input image 31 equals to 662×442, then it will be adjusted to 220×146 after zooming in 3 times larger. Also, given the coordinates of the original input image 31 are (0, 0, 662, 442), they will be adjusted to (0, 0, 220, 146) respectively after zooming in 3 times larger. In this embodiment, the resolution and coordinates of the 4 corners are even-numbered.

The center positions of each sampled image among N×N input sub-images are then calculated (step S203). Since the input image 31 is to be zoomed in N times (both vertically and horizontally) and divided into N×N output sub-images, the sampled center positions of each sub-image must be calculated, for which every sub-image is outputted onto each tile of the tiled image display. The sampled center position of each sub-image refers to the coordinates of the central point of both the vertical and horizontal distances. In this embodiment, the center positions of nine sub-images are:
1. (HpositionMin, VpositionMin)
2. (HpositionMid, VpositionMin)
3. (HpositionMax, VpositionMin)
4. (HpositionMin, VpositionMid)
5. (HpositionMid, VpositionMid)
6. (HpositionMax, VpositionMid)
7. (HpositionMin, VpositionMax)
8. (HpositionMid, VpositionMax)
9. (HpositionMax, VpositionMax)

In this embodiment, after zooming in (vertically and horizontally) threefold, the resolution of the input image 31 is re-adjusted accordingly from 662×442 to 220×146, and center positions of the nine sampled sub-images that are outputted onto nine displays are:
1. (110, 73)
2. (331, 73)
3. (552, 73)
4. (110, 221)
5. (331, 221)
6. (552, 221)
7. (110, 369)
8. (331, 369)
9. (552, 369)

After that, the register's values of the scaler will be set up in each display, including the coordinates and the resolution of each input image, while the output display values and the resolution of the display are also set up (step S204).

Lastly, with the use of on-screen displays (OSD), N×N displays are arranged in matrix, and N×N output sub-images are displayed onto the N×N displays (step S205). Each display 32 comprises a scaler, with which values of the register are set up subject to the sampled position of each sampled input image and its sampled resolution to scale up the image and display on the screen.

The above-mentioned method for segmenting an image is setup-friendly yet at the same time achieves the object of dividing an image into several sub-images at a cost-effective way without any addition of external circuits.

Although the present invention has been explained in relation to its preferred embodiment, it is to be understood that many other possible modifications and variations can be made without departing from the scope of the invention as hereinafter claimed.

What is claimed is:

1. A method for segmenting an image by dividing an input image into a plurality of sub-images and displaying said plurality of sub-images onto a plurality of displays to process image magnification, comprising steps as follows:
(A) identifying coordinates of each of the four corners of said input image and calculating the resolution of said input image;
(B) calculating respective sampled positions and resolutions of N×N output sub-images subject to a scale factor of N, wherein said N refers to N times the scaling in both vertical and horizontal directions, the resolution of said N×N output sub-images equals 1/N to the said input image;
(C) calculating respective sampled images' center positions of said N×N output sub-images;
(D) setting up register's values of a scaler in a display, including the coordinates and resolutions of said input image, and setting up the values and resolutions of said display; and
(E) arranging said N×N displays in matrix using on-screen displays (OSD), and displaying said N×N output sub-images onto said N×N displays respectively.

2. The method as claimed in claim 1, wherein said input image is sampled, scaled and outputted using the scalers in said each of N×N displays respectively.

3. The method as claimed in claim 1, wherein in step (A) said input image is a rectangular image, the resolution and coordinates on four corners of said rectangular image are even numbered.

4. The method as claimed in claim 1, wherein in step (B) said scale factor of N is an integer for segmenting said input image into N×N sub-images, which are sampled, scaled and outputted onto said N×N displays.

5. The method as claimed in claim 1, wherein the coordinates and resolutions of said input image and the values and resolutions of said display are set up in step (D).
